(19) United States
(12) Patent Application Publication
(10) Pub. No.: US 2017/0292647 A1
(43) Pub. Date: Oct. 12, 2017

(54) Two Flap Bendable Stand

(71) Applicant: John Loudon, Redding, CA (US)

(72) Inventor: John Loudon, Redding, CA (US)

(21) Appl. No.: 15/480,282

(22) Filed: Apr. 5, 2017

Related U.S. Application Data
(60) Provisional application No. 62/321,134, filed on Apr. 11, 2016.

(51) Int. Cl. F16M 11/38; G06F 1/16; F16M 11/20

(52) U.S. Cl. CPC F16M 11/38; F16M 11/2021; G06F 1/1633

(57) ABSTRACT

The present invention is a small universal smart phone stand that can fit on a key chain. It can stand a smart phone to custom viewing angles. It transforms from flat into a custom smart phone stand, by just bending two flaps. When the flaps are bent, it creates a gap in-between them. This is where a smart phone is held. One flap is the front support, the other is the back support. The angle of which the flaps are bent into, adjusts the angle of the smart phone. The present invention is made of a shape retaining material. That allows the flaps to retain the shape they are bent into.

### SUMMARY

The present applications claims priority to the earlier filed provisional application having Application Number: 62321134 filed on 11 Apr. 2016, and hereby incorporates subject matter of the provisional application in its entirety.

The present invention is a universal smart phone stand, that fits on a key chain. By being attached to a key chain it can conveniently travel with ones smart phone. The present invention can stand almost any smart phone to custom portrait and landscape viewing angles. While being attached or detached to a key chain. It bends from flat into a custom smart phone stand. By just bending two flaps. After use, it could be bent back to flat and be used numerous times.

### BACKGROUND

The present invention relates to a smart phone stand. A smart phone stand main purpose is to have a better viewing angle of the smart phone. Smart phone stands come in all shapes and sizes. There is a desire to have a smart phone stand that can easily travel with a smart phone. There are some portable stands that can (Patents-U.S. 20130270413 A1, U.S. 20100213331 A1, U.S. 20110278421 A1, U.S. 20100090085 A1, U.S. 20110284599 A1, U.S. 20100181458 A1, U.S. Pat. No. 8,950,720 B1, U.S. 20140291469 A1). However, some of these have to be assembled to use. Also, since they use slots or a slot to adjust the viewing angle. The smart phone can only stand at the viewing angles or angle prefabricated in the smart phone stand. Also, other previous inventions are either to big, cost effective or lack the functionality the present invention is able to achieve.

### BRIEF DESCRIPTION OF THE DRAWING

FIG. 1 is a top view showing the cuts for the flaps on the present invention.

FIG. 2 is a side elevation view of the invention.

FIG. 3 is an isometric view of the invention.

FIG. 4 is an isometric view of the invention with the flaps bent.

FIG. 5 is an isometric view of the invention standing a smart phone.

FIG. 6 is a side view of the invention with the flaps bent.

FIG. 7 is side view of the invention with the flaps at the angle of FIG. 6, standing a smart phone.

FIG. 8 is a side view of the invention with the flaps further bent than FIG. 6.

FIG. 9 is a side view of the invention with the flaps at the angle of FIG. 8. Showing the invention standing a smart phone more decline than FIG. 7.

FIG. 10 is a top view of the invention.

FIG. 11 is a elevation side view of the invention with the additional little flap level.

FIG. 12 is a elevation side view of the invention showing the additional little flap bent up with a lobster clasp attached.

FIG. 13 is a top view showing the invention without the eyelet and little flap.

FIG. 14 is a top view showing the invention in various shapes and format.

### DETAIL DESCRIPTION

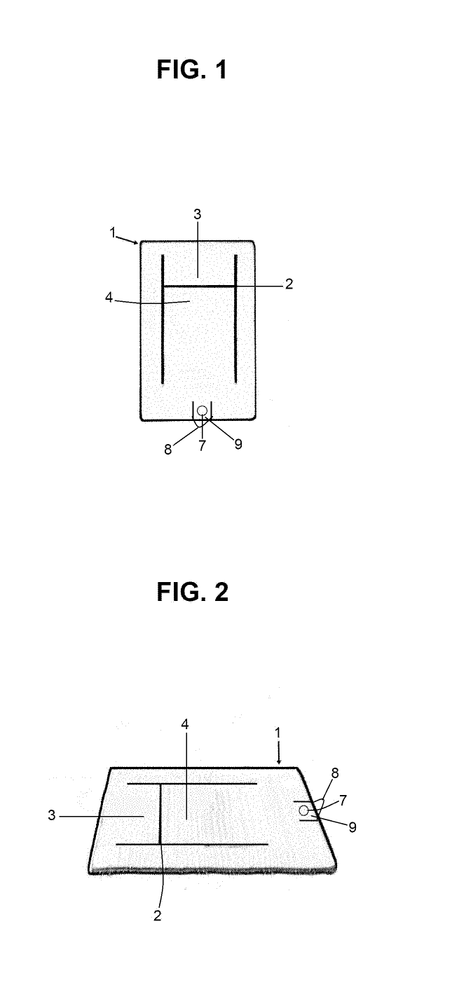

As shown in FIGS. 1-2, the present invention 1 is a flat piece of material. That has a design like the capital letter “H” but with an offset middle line, cut 2 through it. The cut 2 forms two flaps, a short flap 3 and a longer flap 4. The stand 1 is made of a self-retaining material. The material allows the inventions 1 flaps 3, 4 to retain the shape they are bent into.

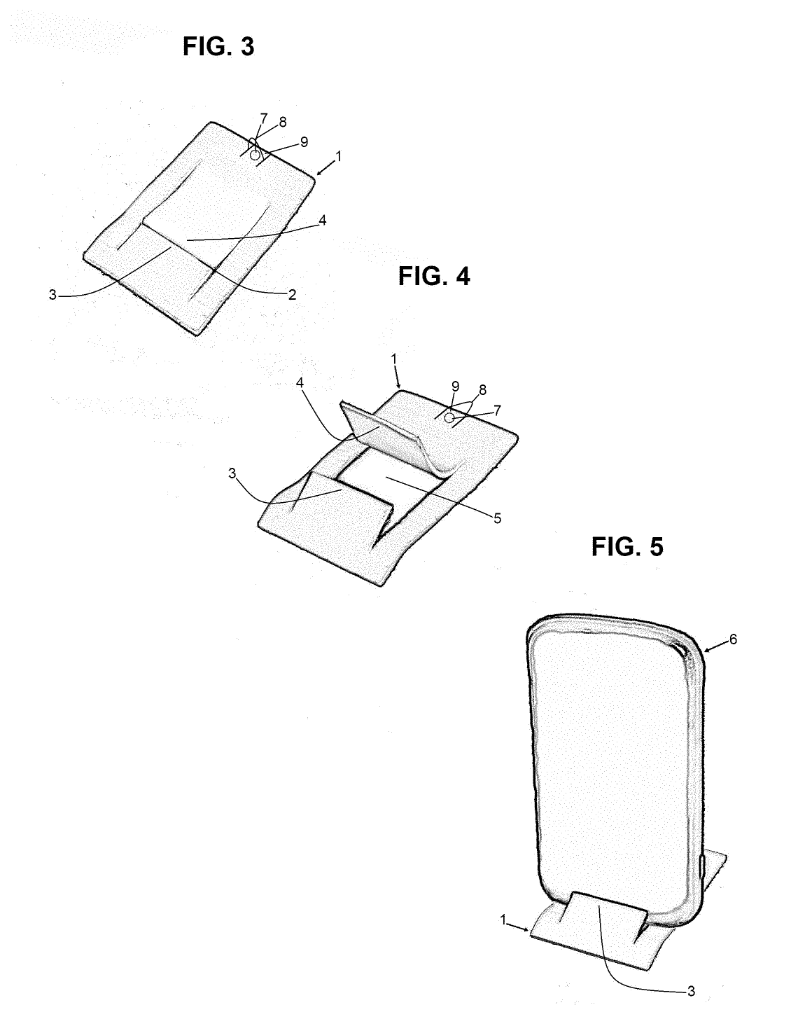

The present invention 1 can transform from being flat to standing a smart phone 6 by bending the flaps 3, 4. When the flaps 3, 4 are bent back, they create a gap 5 in between each other. The gap 5 is where a smart phone 6 is held. The shorter size flap is the front support 3 and the longer size flap is the back support 4. The short flap 3 secures the smart phone 6 in place and the longer flap 4 stands the smart phone 6 up. Shown in FIGS. 3-5.

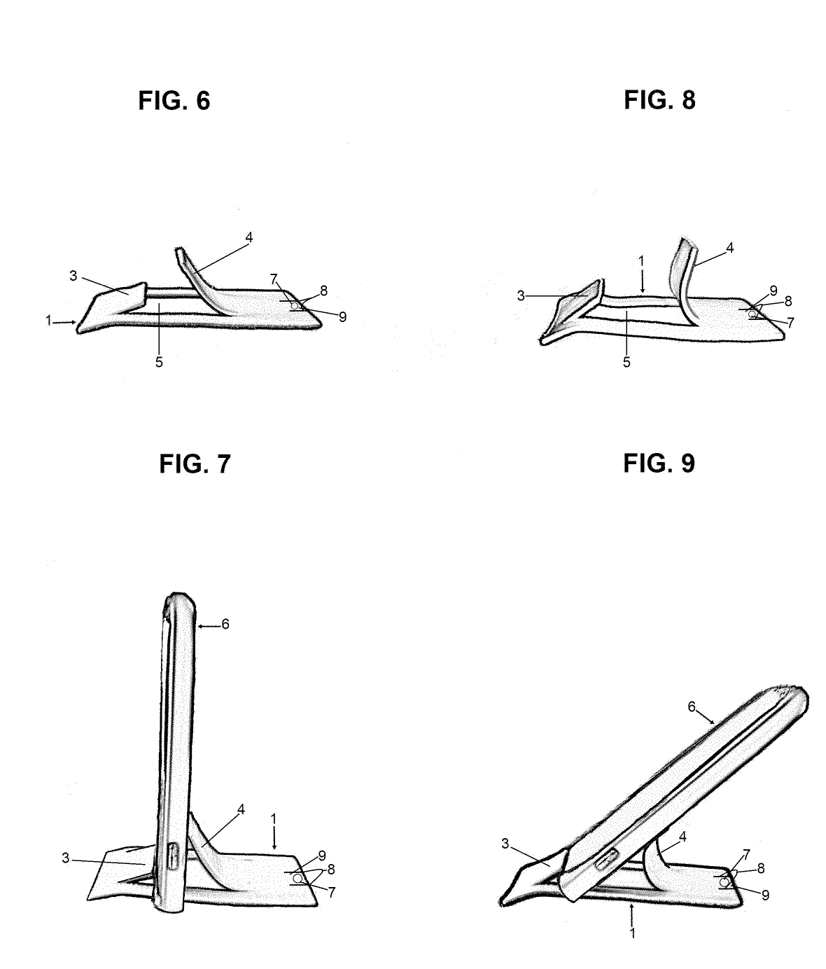

The present invention 1 can stand a smart phone 6 at different angles. The back support 4 adjust most of the smart phones 6 angle. The further the back support 4 is bent, the further the smart phone 6 will decline. This makes the angle at which the smart phone 6 is stood, be custom formed. Shown in FIGS. 6-9.

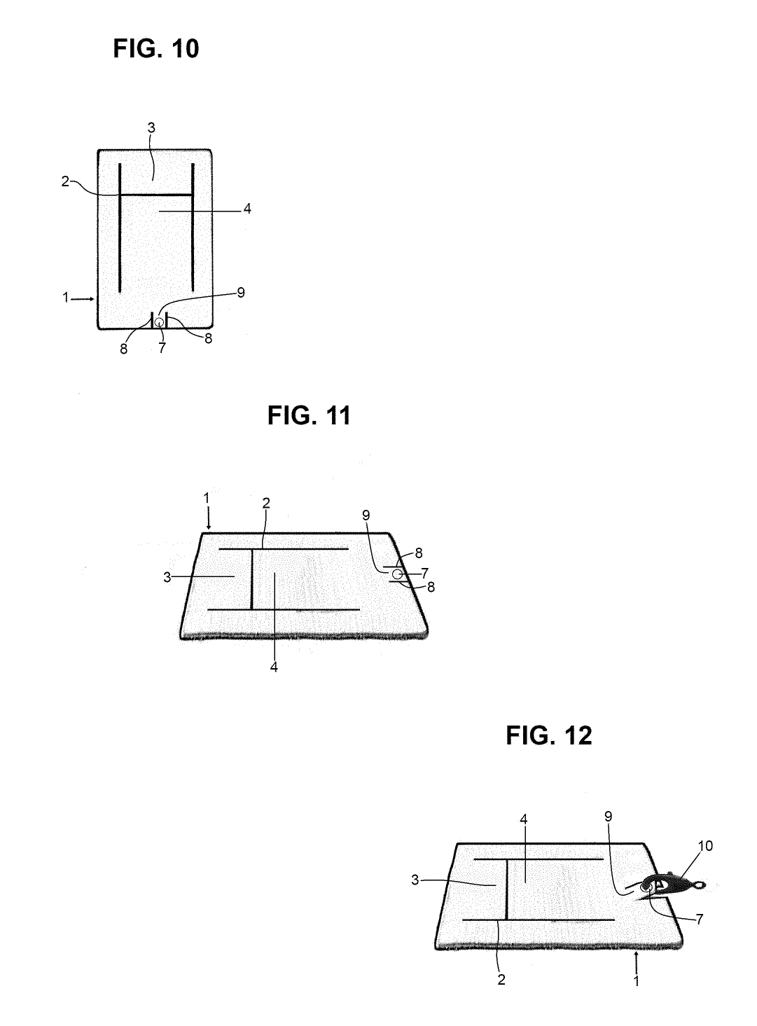

In FIGS. 10-11, The present invention has an eyelet 7 and two small cuts 8 on one end. The eyelet 7, is for the attachment of a lobster clasp 10. That is used to fit on a key chain (key ring). The two small cuts 8 by the eyelet 7 forms a little flap 9. The little flap 9 bends up and allows the invention 1 to lay level to a surface with a lobster clasp 10 attached to it, shown in FIG. 12. Allowing, the present invention 1 to be used while attached to a key chain.

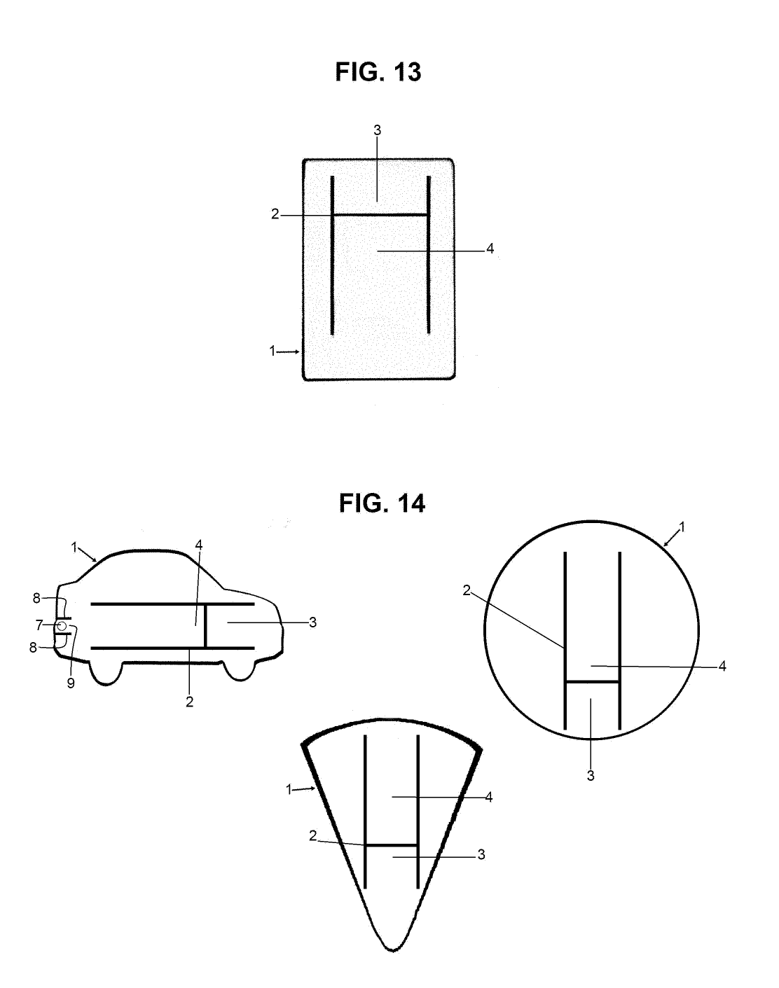

FIG. 13 shows the present invention 1 without a eyelet 7 and little flap 9. The present invention 1 could be used without being fit for a key chain. The two flap bendable stand 1 could be credit card size and held in a wallet. Large size for tablets and other devices. Also, be in different shapes FIG. 14.

What is claimed

1. The present invention two flap function to be used to stand up Smart phones, MP3 players and other like size devices.

2. The present invention two flap function in a larger format to stand up Tablets, E-Readers and other devices.
